(19) United States
(12) Patent Application Publication
(10) Pub. No.: US 2026/0064962 A1
(43) Pub. Date: Mar. 5, 2026

(54) METHOD FOR GENERATING MEETING MINUTES BASED ON GENERATIVE ARTIFICIAL INTELLIGENCE AND COMPUTING DEVICE USING SAME

(71) Applicant: SAMSUNG SDS CO., LTD., Seoul (KR)

(72) Inventors: Deokhyeong LEE, Seoul (KR); Yonghee KIM, Seoul (KR); Sungwon BAEK, Seoul (KR); Youngkyu BAE, Seoul (KR); Heetae YOON, Seoul (KR)

(73) Assignee: SAMSUNG SDS CO., LTD., Seoul (KR)

(21) Appl. No.: 19/237,271

(22) Filed: Jun. 13, 2025

(30) Foreign Application Priority Data
Aug. 28, 2024 (KR) 10-2024-0116228
Oct. 30, 2024 (KR) 10-2024-0150883

(51) Int. Cl. G06F 40/20

(52) U.S. Cl. CPC G06F 40/20

(57) ABSTRACT

The disclosure relates to a generative AI (artificial intelligence)-based meeting minutes generation method and a computing device using the same, and a generative AI-based meeting minutes generation method using a computing device according to an embodiment of the disclosure may include: collecting transcript text generated during a meeting to generate respective data chunks for every configured unit; summarizing the transcript text included in the data chunks to generate interim summary data for each data chunk using a large language model (LLM); grouping the data chunks by reference number to generate multiple topic groups and generating topic text encompassing the interim summary data for each topic group using the large language model; and inputting the topic text and the interim summary data for each topic group into the large language model to generate topic-wise summary data obtained by summarizing the interim summary data according to the topic text.

### CROSS-REFERENCE TO RELATED APPLICATION(S)

This application is based on, and claims priority under 35 U.S.C. 119 to, Korean Patent Applications No. 10-2024-0116228, filed on Aug. 28, 2024, and No. 10-2024-0150883, filed on Oct. 30, 2024, in the Korean Intellectual Property Office, the disclosures of which are hereby incorporated by reference in their entirety.

### BACKGROUND OF THE INVENTION

### 1. Field of the Invention

The disclosure relates to a generative AI-based meeting minutes generation method for automatically generating meeting minutes using a transcript of a video conference and a computing device using the same.

### 2. Description of the Prior Art

Video conferencing service is a service similar to a physical meeting, which enables multiple participants to share voice and video by displaying the video transmitted and received through a network on each participant's screen.

Recently, a function of automatically creating meeting minutes by utilizing generative AI (artificial intelligence) has been applied to video conferencing services. This meeting minutes creation function is a function of appropriately summarizing the main content of the meeting, which may create meeting minutes, based on media data such as video or voice data received from the respective terminals.

However, in the case where the meeting is longer than 1 hour, the amount of transcript may be huge. In this case, the transcript may be divided into data chunks capable of being processed by a large language model (LLM) to be summarized, and repeatedly reduced until the summarized result falls within an input token size of the large language model, and then final summarization was performed to create meeting minutes.

As described above, in the case where the transcript is large in volume, it may be difficult to process the same due to the input token limit of the large language model or the like. That is, the data chunks to be summarized may increase, and the processing time of the large language model for summarization may increase, which may cause system errors such as exceeding the response time limit.

In addition, a large amount of transcript may bring about problems in which the large language model incorrectly summarizes the meeting minutes due to hallucination, and problems in which the meeting minutes is truncated because the summary exceeds the size of the output token of the large language model due to malfunctions such repeating meaningless phrases.

In addition, there may be problems such as summarizing small talk such as greetings or well-being inquiries exchanged between participants during the meeting. That is, a problem in which the meeting minutes are created by focusing on small talk, which is not related to the main topic of the meeting, as main discussions, thereby providing unuseful information to the user, may occur.

### SUMMARY OF THE INVENTION

The disclosure is to provide a generative AI-based meeting minutes generation method capable of automatically generating meeting minutes using a transcript of a video conference, and a computing device using the same.

The disclosure is to provide a generative AI-based meeting minutes generation method capable of generating topic-wise meeting minutes by summarizing the discussions of a meeting by topic, and a computing device using the same.

The disclosure is to provide a generative AI-based meeting minutes generation method capable of removing small talk between participants, which is irrelevant to the main topic discussed in a meeting, when generating meeting minutes, and a computing device using the same.

The disclosure is to provide a generative AI-based meeting minutes generation method capable of improving system errors such as processing time delay or response time exceedance caused by the length of a transcript, and a computing device using the same.

The disclosure is to provide a generative AI-based meeting minutes generation method capable of preventing hallucination and meeting minutes truncation that may occur when generating meeting minutes, and a computing device using the same.

A method for generating meeting minutes based on generative AI (artificial intelligence) using a computing device according to an embodiment of the disclosure may include: collecting transcript text generated during a meeting to generate respective data chunks for every configured unit; summarizing the transcript text included in the data chunks to generate interim summary data for each data chunk using a large language model (LLM); grouping the data chunks by reference number to generate multiple topic groups and generating topic text encompassing the interim summary data for each topic group using the large language model; and inputting the topic text and the interim summary data for each topic group into the large language model to generate topic-wise summary data obtained by summarizing the interim summary data according to the topic text.

Here, the generating of the interim summary data may include excluding small talk text corresponding to predefined small talk from the transcript text included in the data chunk, thereby generating the interim summary data, using the large language model.

Here, the generating of the interim summary data may include excluding the small talk text by utilizing few-shot learning using a prompt including a definition of the small talk and an example corresponding to the small talk text.

Here, the generating of the interim summary data may include, in a case where generation of the interim summary data is impossible when the small talk text is excluded from the data chunk, displaying the data chunk as a preset identifier.

Here, the generating of the topic text may include filtering out the data chunk indicated by the identifier and then generating the topic group.

Here, the generating of the topic-wise summary data may further include: identifying whether small talk text corresponding to predefined small talk is included in the topic-wise summary data using the large language model; and removing, in a case where small talk text is included, the small talk text from the topic-wise summary data using the large language model.

Here, the identifying whether the small talk text is included may include identifying whether the small talk text is included using few-shot learning using a prompt including a definition of the small talk and an example corresponding to the small talk text.

Here, the identifying whether the small talk text is included may include further inputting the topic text corresponding to the topic-wise summary data into the large language model to reflect similarity with the topic text when identifying whether the small talk text is included in the topic-wise summary data.

Here, the generating of the topic text may include variably configuring the number of topics corresponding to the number of the topic groups and the reference numbers of the data chunks included in the topic groups, depending on the number of generated data chunks.

Here, the generating of the topic text may include: obtaining, in a case where the number of data chunks is C, where the number of topics is T, and where the maximum reference number is M (C, T, and M are all integers greater than or equal to 0), the number of topics (T), which is a minimum value that satisfies both C≤T*M and M=T−1, depending on the number of data chunks (C); and configuring the reference numbers of the topic groups, respectively, according to the number of topics (T).

Here, the method for generating meeting minutes based on generative AI according to an embodiment of the disclosure may further include collating the topic-wise summary data to generate topic-specific meeting minutes corresponding to the meeting.

A computer program according to an embodiment of the disclosure may be stored in a medium to execute, in combination with hardware, the generative AI-based meeting minutes generation method described above.

A computing device for generating meeting minutes based on generative AI (artificial intelligence) may include a processor, and the processor may be configured to: collect transcript text generated during a meeting to generate respective data chunks for every configured unit; summarize the transcript text included in the data chunks to generate interim summary data for each data chunk using a large language model (LLM); group the data chunks by reference number to generate multiple topic groups and generate topic text encompassing the interim summary data for each topic group using the large language model; and input the topic text and the interim summary data for each topic group into the large language model to generate topic-wise summary data obtained by summarizing the interim summary data according to the topic text.

Here, in generating the interim summary data, small talk text corresponding to predefined small talk may be excluded from the transcript text included in the data chunk, thereby generating the interim summary data, using the large language model.

Here, in generating the interim summary data, the small talk text may be excluded by utilizing few-shot learning using a prompt including a definition of the small talk and an example corresponding to the small talk text.

Here, when generating the interim summary data, in a case where generation of the interim summary data is impossible when the small talk text is excluded from the data chunk, the data chunk may be displayed as a preset identifier.

Here, in generating the topic text, the topic group may be generated by filtering out the data chunk indicated by the identifier.

Here, the generating of the topic-wise summary data may further include: identifying whether small talk text corresponding to predefined small talk is included in the topic-wise summary data using the large language model; and removing, in a case where small talk text is included, the small talk text from the topic-wise summary data using the large language model.

Here, in generating the topic text, the number of topics corresponding to the number of the topic groups and the reference numbers of the data chunks included in the topic groups may be variably configured depending on the number of generated data chunks.

Here, in generating the topic text, in a case where the number of data chunks is C, where the number of topics is T, and where the maximum reference number is M (C, T, and M are all integers greater than or equal to 0), the number of topics (T), which is a minimum value that satisfies both C≤T*M and M=T−1, may be obtained depending on the number of data chunks (C), and the reference numbers of the topic groups may be respectively configured according to the number of topics (T).

In addition, the above-mentioned solutions to problems do not list all the features of the disclosure. The various features of the disclosure and the advantages and effects thereof will be understood in more detail with reference to the specific embodiments below.

According to a generative AI-based meeting minutes generation method according to an embodiment of the disclosure and a computing device using the same, it is possible to automatically generate meeting minutes using a transcript for a video conference. In addition, it is possible to improve system errors such as processing time delay or response time exceedance caused by the length of a transcript and to prevent hallucination and meeting minutes truncation that may occur when generating meeting minutes.

According to a generative AI-based meeting minutes generation method according to an embodiment of the disclosure and a computing device using the same, since topic-wise meeting minutes can be generated by summarizing the discussions of a meeting by topic, so that the user is able to identify the content of the meeting more clearly.

According to a generative AI-based meeting minutes generation method according to an embodiment of the disclosure and a computing device using the same, it is possible to remove small talk between participants, which is irrelevant to the main topic discussed in a meeting, when generating meeting minutes. That is, information unnecessary to the user can be removed from the meeting minutes, thereby improving user convenience.

However, the effects obtainable from the generative AI-based meeting minutes generation method according to the embodiments of the disclosure and the computing device using the same are not limited to those mentioned above, and other effects that are not mentioned will be clearly understood by those skilled in the art to which the disclosure belongs from the description below.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a schematic diagram illustrating a meeting minutes generation system according to an embodiment of the disclosure;

FIG. 2A is a schematic diagram illustrating generation of meeting minutes for a transcript of a short meeting using a large language model;

FIG. 2B is a schematic diagram illustrating generation of meeting minutes for a transcript of a long meeting using a large language model;

FIG. 3A is a diagram illustrating an example of small talk included in the generation of meeting minutes using a large language model;

FIG. 3B is a diagram illustrating an example of generating topic-wise meeting minutes according to an embodiment of the disclosure;

FIG. 4 is a block diagram illustrating a meeting minutes generation device according to an embodiment of the disclosure;

FIG. 5 is a schematic diagram illustrating generation of meeting minutes using a meeting minutes generation device according to an embodiment of the disclosure;

FIG. 6 is a table illustrating distribution of reference numbers of topic groups depending on the number of data chunks according to an embodiment of the disclosure;

FIG. 7 is a schematic diagram illustrating removal of small talk according to an embodiment of the disclosure;

FIG. 8 is a block diagram illustrating a computing environment suitable for use in exemplary embodiments of the disclosure; and

FIG. 9 is a flowchart illustrating a generative AI-based meeting minutes generation method according to an embodiment of the disclosure.

### DETAILED DESCRIPTION OF THE EXEMPLARY EMBODIMENTS

Hereinafter, the embodiments disclosed in this specification will be described in detail with reference to the attached drawings. Regardless of the reference numerals, identical or similar elements will be assigned the same reference numerals, and redundant descriptions thereof will be omitted. The terms “module” and “unit” used for elements in the following description are assigned or used interchangeably only for the convenience of drafting the specification, and do not have distinct meanings or roles in themselves. That is, the term “unit” used in the disclosure indicates software or a hardware element such as FPGA or ASIC, and the “unit” performs a certain role. However, the “unit” is not limited to software or hardware. The “unit” may be configured to reside in an addressable storage medium or may be configured to reproduce one or more processors. Accordingly, as an example, “units” include elements such as software elements, object-oriented software elements, class elements, and task elements, processes, functions, properties, procedures, subroutines, segments of program code, drivers, firmware, microcode, circuits, data, databases, data structures, tables, arrays, and variables. The functions provided by the elements and “units” may be combined into a smaller number of elements and “units” or may be further divided into additional elements and “units.”

In addition, in describing the embodiments disclosed in this specification, a detailed description of a related known technology, which may obscure the subject matter of the embodiments disclosed in this specification, will be omitted. In addition, the attached drawings are only intended to facilitate easy understanding of the embodiments disclosed in this specification, and the technical ideas disclosed in this specification are not limited to the attached drawings, and should be understood to include all modifications, equivalents, or substitutes included in the scope of the disclosure.

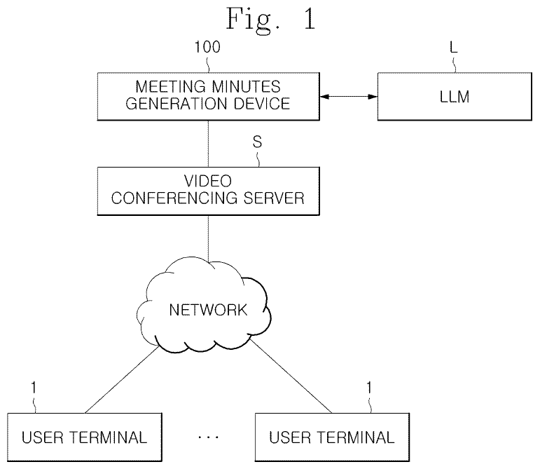

FIG. 1 is a schematic diagram illustrating a meeting minutes generation system according to an embodiment of the disclosure.

A meeting minutes generation system, illustrated in FIG. 1, according to an embodiment of the disclosure may include a user terminal 1, a video conferencing server S, a large language model (LLM) (hereinafter referred to as LLM) L, and a meeting minutes generation device 100.

Hereinafter, a meeting minutes generation system according to an embodiment of the disclosure will be described with reference to FIG. 1.

The user terminal 1 may access the video conferencing server S using a wired or wireless network and receive video conferencing services through the video conferencing server S. A user may transmit media data including video or voice using the user terminal 1 and receive media data such as video or voice transmitted from the other party's user terminal 1 through the video conferencing server S, thereby performing a video conference. Although FIG. 1 shows that the user terminal 1 performs a video conference with another user terminal 1 through the video conferencing server S, the video conference may also be performed through P2P (Peer-to-Peer) communication between the user terminals 1 depending on the embodiment.

The user terminal 1 may be equipped with a communication module for transmitting and receiving information, a memory for storing programs and protocols, and a processor for executing various programs to perform computation and control. In addition, the user terminal 1 may further include devices for performing a video conference, such as cameras, microphones, speakers, and displays. Here, the respective devices may be equipped in the user terminal 1 or connected to the user terminal 1 by wired or wireless communication.

The user terminal 1 may be a mobile terminal such as a smartphone or tablet PC, or a fixed terminal such as a desktop PC. For example, the user terminal 1 may include a mobile phone, a smartphone, laptop a digital a computer, broadcasting terminal, a personal digital assistant (PDA), a portable multimedia player (PMP), a slate PC, a tablet PC, an ultra-book, a wearable device (e.g., a smartwatch, smart glasses, or a head-mounted display (HMD)), or the like.

The network may include a wired network and a wireless network and, specifically, may include various networks such as a local area network (LAN), a metropolitan area network (MAN), and a wide area network (WAN). In addition, the network may include the World Wide Web (WWW) as known in the art. However, the network according to the disclosure is not limited to the networks listed above, and may include a known wireless data network, a known telephone network, a known wired or wireless television network, or the like.

The video conferencing server S may provide video conferencing services between the user terminals 1. The video conferencing server S may relay the transmission of media data between the user terminals 1 or perform configuration for P2P communication between the user terminals 1. That is, the video conferencing server S may perform a relay function of receiving each piece of media data transmitted by the user terminals 1 and transmitting it to a corresponding user terminal 1, or may provide configuration information or the like for the user terminals 1 to transmit media data to each other through P2P communication.

Here, the media data may include video data or voice data generated during a video conference. For example, the video data may include a video shot by a camera of the user terminal 1 during a video conference, or a screen sharing video of a screen displayed on a display unit in the user terminal 100 during screen sharing. In addition, the voice data may include the user's voice, ambient sound, or sound effects input through a microphone of the user terminal 1.

The meeting minutes generation device 100 may generate meeting minutes by summarizing and organizing the content of a meeting, based on media data transmitted by the user terminals 1 through a video conference. Here, the meeting minutes generation device 100 may receive media data from the video conferencing server S, which has been transmitted by the user terminals 1, and generate summarized meeting minutes, based on this.

The meeting minutes generation device 100 may include resources such as a processor and a memory, and may provide services such as meeting minutes generation based on generative AI (artificial using the same. Here, the meeting minutes generation device 100 may have various models built based on generative AI, and may perform operations such as natural language processing in association with the LLM L using the generative AI model. The LLM L may be, for example, GPT (Generative Pre-trained Transformer), LLaMA (Large Language Model Meta AI), etc., and in addition, various types of LLMs L may be utilized depending on the embodiment.

Specifically, the meeting minutes generation device 100 may automatically generate meeting minutes for a video conference, based on generative AI, and, when a query is input from the user terminal 1, generate and provide, based on the generated meeting minutes, an appropriate response based on natural languages.

Although FIG. 1 illustrates the meeting minutes generation device 100 as a separate component from the video conferencing server S, the meeting minutes generation device 100 and the video conferencing server S may be implemented as a single component depending on the embodiment. That is, the meeting minutes generation device 100 may be implemented to include the functions of the video conferencing server S. In addition, depending on the embodiment, the meeting minutes generation device 100 may separately receive the recording of a corresponding meeting and also generate the summarized meeting minutes, based on the recording.

In the past, the transcript was divided into data chunks capable of being processed by the LLM to be summarized, and repeatedly reduced until the summarized result falls within an input token size of the large language model, and then final summarization was performed to create meeting minutes.

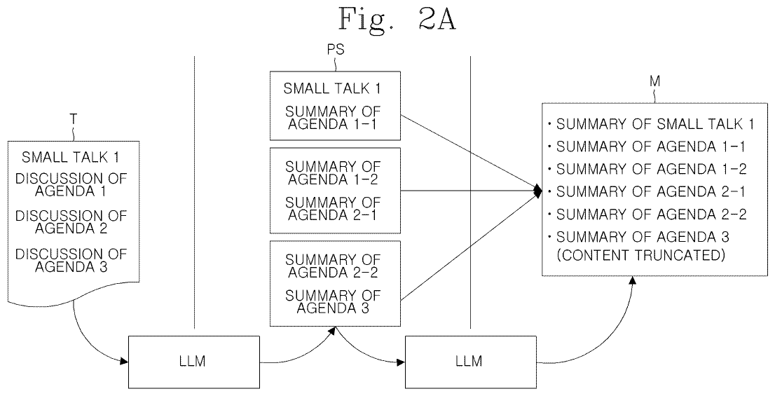

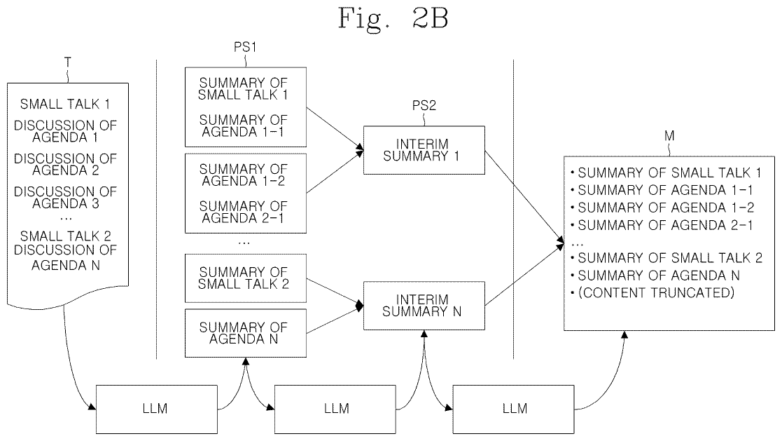

For example, in the case where a meeting is relatively short, less than 1 hour, as shown in FIG. 2A, when a transcript T is input, an interim summary PS may be generated once for each data chunk using the LLM, and the respective interim summaries PS may be summarized again by the LLM to generate the final meeting minutes M.

However, in the case where the meeting is longer than 1 hour, as shown in FIG. 2B, a first interim summary PS1 may be generated from the transcript T, and then a configured number of first interim summaries PS1 may be grouped to generate a second interim summary PS2. Since the number of data chunks increases as the meeting gets longer, if the first interim summaries PS1 are input into the LLM at once, the maximum number of input tokens of the LLM may be exceeded. Therefore, multiple first interim summaries PS1 may be grouped to preferentially generate a second interim summary PS2, and the second interim summaries PS2 may be summarized to generate the final meeting minutes M. In this embodiment, although up to the second interim summary PS2 is generated, a third or fourth interim summary may also be generated depending on the length of the meeting.

As described above, if the amount of transcript T is large, it may be difficult to process the same due to the input token limit of the LLM or the like. That is, the data chunk to be summarized may increase, and the processing time of the LLM for summary may increase, which may cause system errors such as exceeding the response time limit.

In addition, a large amount of transcript may bring about problems in which the LLM incorrectly summarizes the meeting minutes due to hallucination, and problems in which the meeting minutes is truncated because the summary exceeds the size of the output token of the LLM due to malfunctions such as repeating meaningless phrases.

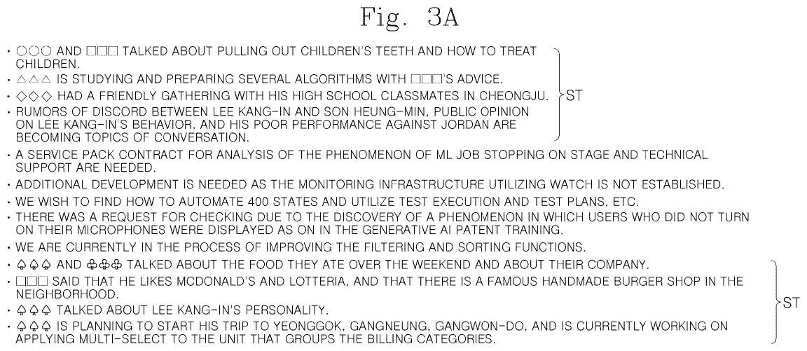

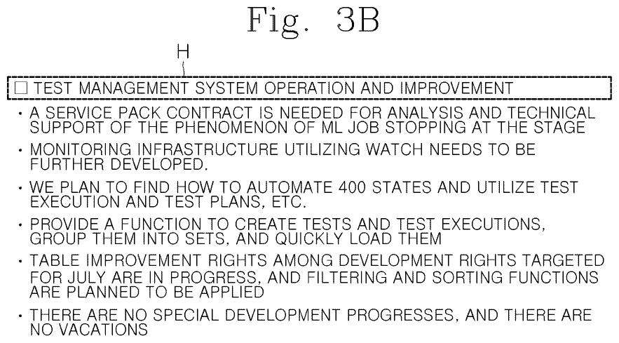

Furthermore, there may be problems such as summarizing small talk such as greetings or well-being inquiries exchanged between participants during the meeting. That is, referring to FIG. 3A, it can be seen that unnecessary small talk ST is included in the meeting minutes. As described above, a problem in which the meeting minutes are created by focusing on small talk, which is not related to the main topic of the meeting, as main discussions, thereby providing unuseful information to the user, may occur.

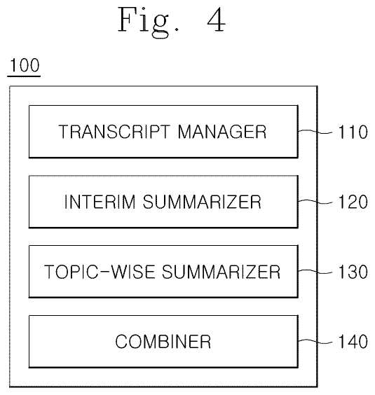

Accordingly, the meeting minutes generation device 100 according to an embodiment of the disclosure may generate meeting minutes by selecting a topic for each section of the meeting, performing summarization according to the selected topic, and combining the summarized results. In this case, it is possible to improve the response time of meeting minutes generation and to prevent phenomena such as incorrect answers due to hallucination or truncation of meeting minutes. In addition, since it is possible to remove small talk while performing summarization by topic, it is possible to generate and provide meeting minutes focused on the meeting topic from which the small talk has been removed. That is, as shown in FIG. 3B, topic-wise meeting minutes may be generated, and topic text H corresponding to each topic may be provided together. Therefore, the user is able to identify the topic from the topic text H and more easily understand the summarized meeting content related to the topic. Hereinafter, a meeting minutes generation device 100 according to an embodiment of the disclosure will be described with reference to FIG. 4.

FIG. 4 is a block diagram illustrating a meeting minutes generation device according to an embodiment of the disclosure.

Referring to FIG. 4, a meeting minutes generation device 100 according to an embodiment of the disclosure may include a transcript manager 110, an interim summarizer 120, a topic-wise summarizer 130, and a combiner 140.

The transcript manager 110 may collect transcript text generated during a meeting and generate data chunks for every configured unit. Specifically, the transcript manager 110 may receive transcript text obtained by converting user speech collected during a meeting into text, based on STT (Speech-to-Text). That is, the transcript manager 110 may collect transcript text input in real time during the meeting, and generate a transcript by combining the transcript text in chronological order. Here, the transcript may be continuously updated by sequentially input transcript text, and it is also possible to receive transcripts for already finished meetings depending on the embodiment.

The transcript manager 110 may collect respective input transcript texts and generate data chunks for every configured unit, and may store the generated data chunks in a database. At this time, the configured unit may be a time for collecting transcript text, the number of words included in the transcript text, a file size of the transcript text, or the like.

Specifically, each transcript text may further include information as metadata about the time at which the speech corresponding to the corresponding transcript text was recorded, and this may be used to identify information about the time at which each speech was made. In this case, the transcript manager 110 may configure the configured unit to a certain time (e.g., 3 minutes) and collect transcript texts corresponding to the users' speech during the time and generate one data chunk.

In addition, since the maximum number of input tokens capable of being processed by the LLM L is fixed, the configured unit may be the number of words included in the data chunk by reflecting the same. That is, when transcript texts corresponding to a preset number of words are collected, a new data chunk may be generated. For example, in the case where the maximum number of input tokens of the LLM L is 4000 tokens, since one word takes up about 1 to 2 tokens on average, 4000 tokens may correspond to 2000 to 3000 words. Here, although one data chunk may be configured to include 2000 to 3000 words, the number of words included in the data chunk may be appropriately adjusted in consideration of the performance of the LLM L. That is, the number of words may be configured to be large such that the LLM L is able to sufficiently understand the content, but not to be so large, thereby preventing the quality of summary data for the data chunk from deteriorating. For example, the transcript manager 110 may configure the configured unit so that one data chunk includes 500 to 1, 500 words, thereby generating each data chunk. However, it is not limited thereto, and the number of words included in one data chunk may be adjusted in various ways depending on the embodiment.

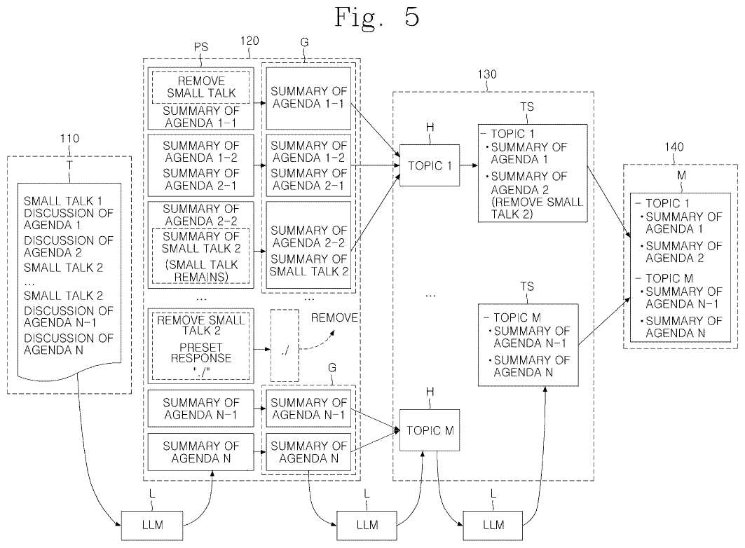

The interim summarizer 120 may summarize transcript text included in the data chunk and generate interim summary data for each data chunk using the LLM. Referring to FIG. 5, the interim summarizer 120 may receive data chunks for the transcript T of the transcript manager 110 and generate interim summary data PS for each data chunk using the LLM L. At this time, the interim summarizer 120 may input a data chunk to the LLM L with a preset prompt to request generation of interim summary data PS, and the LLM L may provide interim summary data corresponding to the data chunk.

At this time, the interim summarizer 120 may generate interim summary data PS by excluding small talk text corresponding to predefined small talk from the transcript text included in the data chunk using the LLM L. Specifically, the interim summarizer 120 may enable the LLM L to exclude small talk text when generating the interim summary data PS using few-shot learning including a prompt including a definition of small talk and examples corresponding to small talk text.

That is, the interim summarizer 120 may provide a data chunk to the LLM L and further include a few-shot learning prompt including a dictionary definition of small talk and types of examples corresponding to small talk in the prompt for requesting generation of interim summary data PS, enabling to exclude the small talk text corresponding to the small talk. In this case, the LLM L may exclude small talk text from the transcript text included in the data chunk and then perform summarization on the remaining transcript text to generate interim summary data PS.

For example, as shown in FIG. 5, it can be seen that the data chunk contains “small talk 1” and “discussion of agenda 1-1”, but that the interim summary data PS generated for the corresponding data chunk contains only the summary of agenda 1-1 while removing the small talk. However, depending on the embodiment, small talk may remain in the interim summary data PS generated by the interim summarizer 120, and in this case, the remaining small talk may be removed again when generating topic-wise summary data.

Additionally, there may be the case where the entire data chunk corresponds to small talk, and in this case, summarization of the corresponding data chunk is impossible if small talk text is excluded. For this case, that is, in the case where summarization of the data chunk is impossible if small talk text is excluded, the interim summarizer 120 may further include a prompt indicating the corresponding data chunk as a preset identifier and input it into the LLM L. In this case, the LLM L may output a preset identifier such as “./” corresponding to the data chunk that only contains small talk text. Through this, the data chunk that only contains small talk text may be easily distinguished, and the corresponding data chunk may be excluded when generating topic summary data later. Depending on the embodiment, it is also possible to include a preset identifier in the interim summary data PS for the corresponding data chunk.

As shown in FIG. 5, the topic-wise summarizer 130 may group data chunks or interim summary data PS by reference number to generate multiple topic groups G, and may generate topic text H encompassing interim summary data PS for each topic group G using the LLM L.

That is, in order to generate topic-wise summary data, data chunks expected to contain the same topic may be preferentially grouped to generate one topic group G, and topic text H indicating the topic corresponding to the topic group G may be generated for each topic group G. At this time, the topic-wise summarizer 130 may generate the topic group G while filtering and excluding data chunks indicated by preset identifiers. That is, since the data chunks indicated by the identifiers only contain small talk text, they may be excluded from the topic group G.

Here, the topic-wise summarizer 130 may variably configure the number of topics corresponding to the number of topic groups G and the reference number of data chunks included in the topic groups G depending on the number of generated data chunks. Referring to FIG. 5, it can be seen that there are cases where the same agenda 1 is divided into different data chunks or where agendas 1-2 and 2-1 of different topics are included in one data chunk. That is, it may be difficult to group data chunks that actually contain the same topic into one topic group G. Therefore, the topic-wise summarizer 130 may variably configure the number of topic groups G and the reference number, which is the number of data chunks included in the topic group G, depending on the number of data chunks such that the LLM L may easily derive topics from the respective topic groups G.

Specifically, in the case where the number of data chunks is C, where the number of topics is T, and where the maximum reference number is M (C, T, and M are all integers greater than or equal to 0), the topic-wise summarizer 130 may obtain the number of topics T, which is the minimum value that satisfies both C≤T*M and M=T−1, depending on the number of data chunks C. For example, the case of selecting the number of topics T will be described when the number of data chunks C is 17. Assuming that T=2, since 17≤2*(2−1), the inequality does not hold. Therefore, 1 may be added to T and then the inequality may be re-evaluated. Assuming T=3, since 17≤3*(3−1), the inequality does not hold, so 1 is added to T and the inequality is re-evaluated. Assuming T=4, since 17≤4*(4−1), the inequality does not hold, so 1 is added to T and the inequality is re-evaluated. Assuming T=5, since 17≤5*(5−1) holds, T may be determined as 5. Here, since T=5 corresponds to the minimum value for which the above inequality holds, the topic-wise summarizer 130 may generate 5 topic groups G.

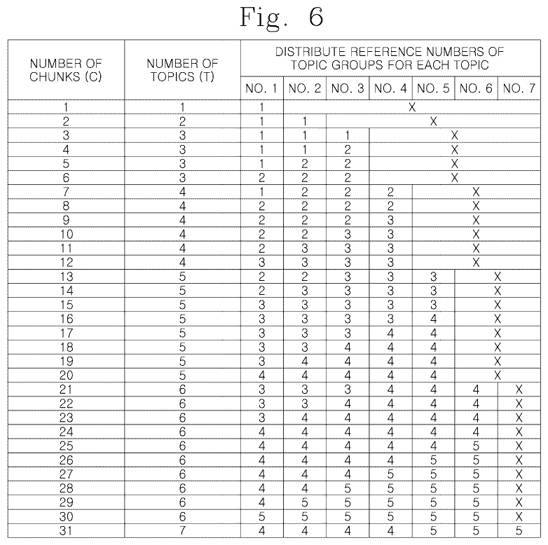

After that, the topic-wise summarizer 130 may distribute the reference numbers of the topic groups G according to the number of topics T. That is, the reference number corresponding to the number of data chunks to be included in each topic group G may be configured. For example, in the case where 5 topic groups G are generated for 17 data chunks, the 17 data chunks may be evenly distributed to the 5 topic groups G, thereby configuring the reference number for each topic group G. Specifically, the topic-wise summarizer 130 may perform C/T to obtain the quotient and remainder. Here, the quotient of 17/5 is 3, and the remainder is 2. Therefore, the reference numbers may be configured such that, among the topic groups G, 3 groups may each include 3 data chunks, and such that the remaining 2 groups may each include 4 data chunks by further including one data chunk. Referring to FIG. 6, the number of topics T depending on the number of data chunks C, and the distribution of reference numbers for respective topic groups G are confirmed. Here, “No. 1” to “No. 7” correspond to the names of topic groups G configured to distinguish between the topic groups G.

Once the respective topic groups G and the respective data chunks included in the topic group G are determined, the topic-wise summarizer 130 may generate topic text from the interim summary data of the respective data chunks included in the topic group G. That is, the topic-wise summarizer 130 may input interim summary data PS included in the same topic group G, along with a preset prompt, to the LLM L and request generation of corresponding topic text H. In this case, the LLM L may provide topic text H corresponding to the interim summary data PS of the topic group G. Here, in the case where M topic groups G are generated, M topic texts may also be generated corresponding to the respective topic groups G.

Afterwards, the topic-wise as summarizer 130, illustrated in FIG. 5, may input the topic text H and the interim summary data PS for each topic group G into the LLM L, thereby generating topic-wise summary data TS obtained by summarizing the interim summary data PS according to the topic text H. At this time, the LLM L may generate the topic-wise summary data TS by summarizing the interim summary data PS by reflecting each topic text H.

Here, each piece of topic-wise summary data TS, as illustrated in FIG. 3B, may display topic text H as a title and display summary content corresponding to the topic text H subsequent thereto. As illustrated in FIG. 5, each piece of topic-wise summary data TS may be generated for each topic group G.

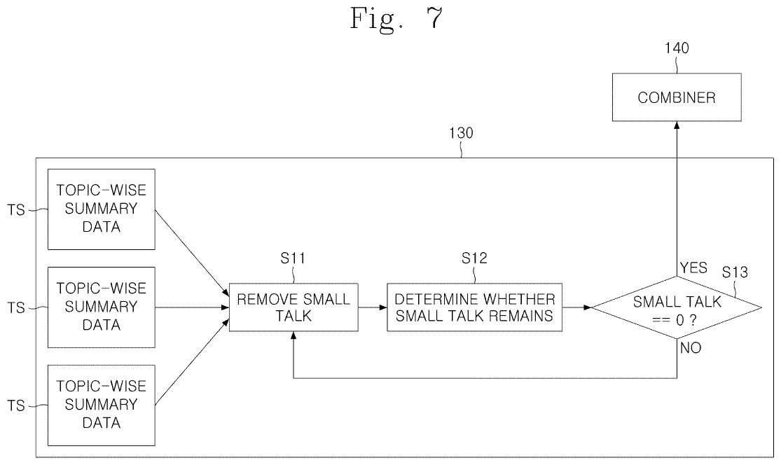

Additionally, depending on the embodiment, the topic-wise summarizer 130 may further identify whether small talk is included in the topic-wise summary data. Referring to FIG. 7, the topic-wise summarizer 130 may remove small talk included in the topic-wise summary data TS using the LLM L (S11), and then determine whether small talk remains in the topic-wise summary data TS using the LLM L (S12).

That is, the topic-wise summarizer 130 may identify whether small talk text corresponding to predefined small talk is included in the topic-wise summary data TS through the LLM, based on a prompt. For example, few-shot learning may be utilized to use a prompt that includes a definition of small talk and examples corresponding to the small talk text, and through this, if the small talk text is included in the topic-wise summary data TS, the corresponding small talk text may be removed.

Depending on the embodiment, topic text H corresponding to the topic-wise summary data TS may be further included in the prompt, so that the similarity with topic text H may be reflected when identifying whether there is small talk text. That is, since the topic-wise summary data TS is obtained through summarization according to the topic text H, it may be seen that content that matches the topic of the corresponding topic text H is included. However, since the small talk text is likely to be unrelated to the topic text H, the small talk may be removed more efficiently by further reflecting the corresponding topic text H when removing the small talk text.

After that, the topic-wise summarizer 130 may identify again whether small talk exists in the corresponding topic-wise summary data TS (S13), and the process may proceed to the operation of the combiner 140 only if there is no small talk. On the other hand, if it is determined that small talk still exists in the topic-wise summary data TS, the small talk may be removed again (S11), and the process of determining whether small talk remains may be repeated (S12).

The combiner 140 may collect the topic-wise summary data to generate topic-wise meeting minutes corresponding to the meeting. For example, the combiner 140 may generate topic-wise meeting minutes by listing the respective pieces of topic-wise summary data TS. However, the disclosure is not limited thereto, and the combiner 140 may also modify the topic-wise summary data by comparing multiple pieces of topic-wise summary data among each other to combine data of similar topics with each other or dividing one piece of topic-wise summary data into multiple pieces of topic-wise summary data before generating the topic-wise meeting minutes. In addition, it is common to generate topic-wise meeting minutes by listing the respective pieces of topic-wise summary data in chronological order, but it is also possible to group data of similar topics and list the same, or to arrange data in an order adjusted according to importance.

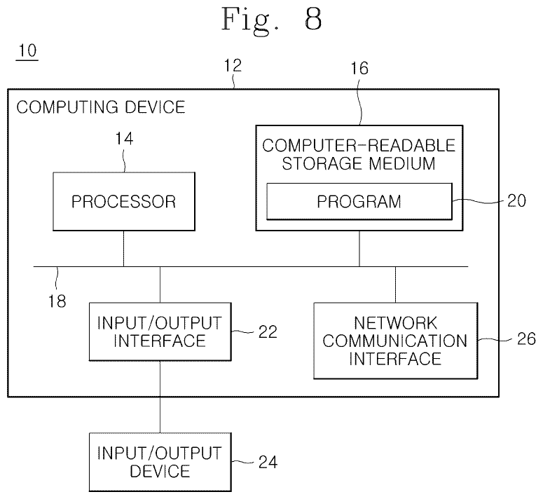

FIG. 8 is a block diagram illustrating a computing environment 10 suitable for use in exemplary embodiments of the disclosure. In the illustrated embodiment, respective components may have different functions and capabilities from those described below, and may further include other components in addition to those described below.

The illustrated computing environment 10 includes a computing device 12. In an embodiment, the computing device 12 may be a generative AI-based meeting minutes generation device 100.

The computing device 12 includes at least one processor 14, a computer-readable storage medium 16, and a communication bus 18. The processor 14 may cause the computing device 12 to operate according to the embodiments described above. For example, the processor 14 may execute one or more programs stored on a computer-readable storage medium 16. The one or more programs may include one or more computer-executable instructions, which may be configured to cause, when executed by the processor 14, the computing device 12 to perform operations according to the embodiments.

The computer-readable storage medium 16 is configured to store computer-executable instructions, program code, program data, and/or other suitable forms of information. The program 20 stored on the computer-readable storage medium 16 includes a set of instructions executable by the processor 14. In an embodiment, the computer-readable storage medium 16 may be memory (volatile memory, such as random-access memory, nonvolatile memory, or a suitable combination thereof), one or more magnetic disk storage devices, optical disk storage devices, flash memory devices, another type of storage medium capable of being accessed by the computing device 12 and storing desired information, or a suitable combination thereof.

The communication bus 18 interconnects various components of the computing device 12, including the processor 14 and the computer-readable storage medium 16.

The computing device 12 may also include one or more input/output interfaces 22 that provide interfaces for one or more input/output devices 24, and one or more network communication interfaces 26. The input/output interfaces 22 and the network communication interfaces 26 are connected to the communication bus 18. The input/output devices 24 may be connected to other components of the computing device 12 via the input/output interfaces 22. For example, the input/output devices 24 may include input devices such as a pointing device (mouse, trackpad, etc.), a keyboard, a touch input device (touchpad, touchscreen, etc.), a voice or sound input device, various types of sensor devices and/or photographing devices, and/or output devices such as a display device, a printer, a speaker, and/or a network card. The exemplary input/output device 24 may be included inside the computing device 12 as a component that constitutes the computing device 12, or may be configured as a separate device distinct from the computing device 12 and then connected to the computing device 12.

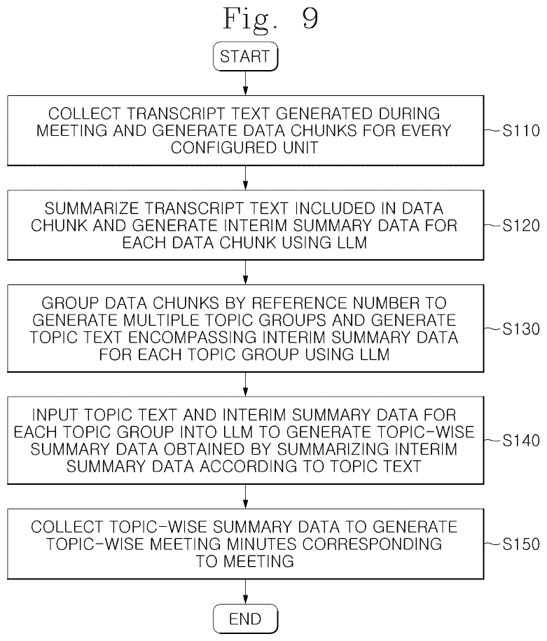

FIG. 9 is a flowchart illustrating a generative AI-based meeting minutes generation method according to an embodiment of the disclosure. Here, the steps shown in FIG. 9 may be performed by a meeting minutes generation device or a computing device according to an embodiment of the disclosure.

Referring to FIG. 9, the computing device may collect transcript text generated during a meeting and generate data chunks for every configured unit (S110). That is, the computing device may receive transcript text obtained by converting user speech collected during a meeting into text, based on STT. The computing device may collect transcript text input in real time during the meeting, and generate a transcript by combining the transcript text in chronological order.

The computing device may collect respective input transcript texts and generate data chunks: for every configured unit, and may store the generated data chunks in a database. At this time, the configured unit may be a time for collecting transcript text, the number of words included in the transcript text, a file size of the transcript text, or the like.

The computing device may summarize transcript text included in the data chunks and generate interim summary data for each data chunk using the LLM (S120). Here, the computing device may input a data chunk to the LLM with a preset prompt to request generation of interim summary data, and the LLM may provide interim summary data corresponding to the data chunk.

At this time, the computing device may generate interim summary data by excluding small talk text corresponding to predefined small talk from the transcript text included in the data chunk using the LLM. That is, the computing device may enable the LLM to exclude small talk text when generating the interim summary data using few-shot learning including a prompt including a definition of small talk and examples corresponding to small talk text. In this case, the LLM may exclude small talk text from the transcript text included in the data chunk and then perform summarization on the remaining transcript text to generate interim summary data.

Additionally, there may be the case where the entire data chunk corresponds to small talk, and in this case, summarization of the corresponding data chunk is impossible if small talk text is excluded. For this case, that is, in the case where summarization of the data chunk is impossible if small talk text is excluded, the computing device may further include a prompt indicating the corresponding data chunk as a preset identifier and input it into the LLM. In this case, the LLM may output a preset identifier such as “./” corresponding to the data chunk that only contains small talk text. Through this, the data chunk that only contains small talk text may be easily distinguished, and the corresponding data chunk may be excluded when generating topic summary data later.

Afterwards, the computing device may group data chunks by reference number to generate multiple topic groups, and may generate topic text encompassing interim summary data for each topic group using the LLM (S130). That is, in order to generate topic-wise summary data, data chunks expected to contain the same topic may be preferentially grouped to generate one topic group, and topic text indicating the topic corresponding to the topic group may be generated for each topic group. At this time, the computing device may generate the topic group while filtering and excluding data chunks indicated by preset identifiers. That is, since the data chunks indicated by the identifiers only contain small talk text, they may be excluded from the topic group.

Here, the computing device may variably configure the number of topics corresponding to the number of topic groups and the reference number of data chunks included in the topic groups depending on the number of generated data chunks. That is, the computing device may variably configure the number of topic groups and the reference number, which is the number of data chunks included in the topic group, depending on the number of data chunks such that the LLM may easily derive topics from the respective topic groups.

Specifically, in the case where the number of data chunks is C, where the number of topics is T, and where the maximum reference number is M (C, T, and M are all integers greater than or equal to 0), the computing device may obtain the number of topics T, which is the minimum value that satisfies both C≤T*M and M=T−1, depending on the number of data chunks C. After that, the computing device may distribute the reference numbers of the topic groups according to the number of topics T. That is, the reference number corresponding to the number of data chunks to be included in each topic group may be configured. For example, in the case where 5 topic groups G are generated for 17 data chunks, the 17 data chunks may be evenly distributed to the 5 topic groups G, thereby configuring the reference number for each topic group.

Afterwards, the computing device may input the topic text and the interim summary data for each topic group into the LLM, thereby generating topic-wise summary data obtained by summarizing the interim summary data according to the topic text (S140).

Once the respective topic groups and the respective data chunks included in the topic group are determined, the computing device may generate topic text from the interim summary data of the respective data chunks included in the topic group. That is, the computing device may input interim summary data included in the same topic group, along with a preset prompt, into the LLM and request generation of corresponding topic text. In this case, the LIM may provide topic text corresponding to the interim summary data of the topic group.

Afterwards, the computing device may input the topic text and the interim summary data for each topic group into the LLM, thereby generating topic-wise summary data obtained by summarizing the interim summary data according to the topic text. At this time, the LLM may generate the topic-wise summary data by summarizing the interim summary data by reflecting each topic text.

Additionally, depending on the embodiment, the computing device may further identify whether small talk is included in the topic-wise summary data. That is, the computing device may determine whether small talk remains in the topic-wise summary data using the LLM and, if small talk remains, remove the small talk included in the topic-wise summary data using the LLM.

Here, the computing device may identify whether small talk text corresponding to predefined small talk is included in the topic-wise summary data through the LLM, based on a prompt. For example, few-shot learning may be utilized to use a prompt that includes a definition of small talk and examples corresponding to the small talk text, and through this, it may be identified whether the small talk text is included in the topic-wise summary data, so that the included small talk text may be removed.

Depending on the embodiment, the computing device may further include topic text corresponding to the topic-wise summary data in the prompt, and may reflect the similarity with topic text when identifying whether there is small talk text. That is, since the topic-wise summary data is obtained through summarization according to the topic text, it may be seen that content that matches the topic of the corresponding topic text is included. However, since the small talk text is likely to be unrelated to the topic text, the small talk may be removed more efficiently by further reflecting the corresponding topic text when removing the small talk text.

After that, the computing device may identify whether small talk exists in the corresponding topic-wise summary data, and the process may proceed to the next step only if there is no small talk. On the other hand, if it is determined that small talk still exists in the topic-wise summary data, the computing device may repeat the operation of identifying whether small talk remains and removing the small talk.

The computing device may collect the topic-wise summary data to generate topic-wise meeting minutes corresponding to the meeting (S150). For example, the computing device may generate topic-wise meeting minutes by listing the respective pieces of topic-wise summary data. However, the disclosure is not limited thereto, and the computing device may also modify the topic-wise summary data by comparing multiple pieces of topic-wise summary data among each other to combine data of similar topics with each other or dividing one piece of topic-wise summary data into multiple pieces of topic-wise summary data before generating the topic-wise meeting minutes. In addition, it is common to generate topic-wise meeting minutes by listing the respective pieces of topic-wise summary data in chronological order, but it is also possible to group data of similar topics and list the same, or to arrange data in an order adjusted according to importance.

The above-mentioned disclosure may be implemented as a computer-readable code on a medium in which a program is recorded. The computer-readable medium may be a medium that continuously stores a computer-executable program or temporarily stores it for execution or download. In addition, the medium may be a variety of recording means or storage means in the form of a single or multiple hardware combinations, and is not limited to a medium directly connected to a computer system, but may also be distributed on a network. Examples of the medium may include magnetic media such as hard disks, floppy disks, and magnetic tapes, optical recording media such as CD-ROMs and DVDs, magneto-optical media such as floptical disks, and ROMs, RAMs, flash memories, etc., configured to store program instructions. In addition, examples of other media include recording media or storage media managed by app stores that distribute applications, or sites or servers that supply or distribute various software. Therefore, the above detailed description should not be construed as limiting the disclosure in all respects and should be considered as examples. The scope of the disclosure should be determined by a reasonable interpretation of the appended claims, and all changes within the equivalent scope of the disclosure are included in the scope of the disclosure.

The disclosure is not limited to the above-described embodiments and the attached drawings. It will be apparent to those skilled in the art to which the disclosure belongs that components according to the disclosure may be substituted, modified, and changed without departing from the technical idea of the disclosure.

What is claimed is:

1. A method for generating meeting minutes based on generative AI (artificial intelligence) using a computing device, the method comprising:
collecting transcript text generated during a meeting to generate respective data chunks for every configured unit;
summarizing the transcript text included in the data chunks to generate interim summary data for each data chunk using a large language model (LLM);
grouping the data chunks by reference number to generate multiple topic groups and generating topic text encompassing the interim summary data for each topic group using the large language model; and
inputting the topic text and the interim summary data for each topic group into the large language model to generate topic-wise summary data obtained by summarizing the interim summary data according to the topic text.

2. The method for generating meeting minutes based on generative AI of claim 1,
wherein the generating of the interim summary data comprises
excluding small talk text corresponding to predefined small talk from the transcript text included in the data chunk, thereby generating the interim summary data, using the large language model.

3. The method for generating meeting minutes based on generative AI of claim 2,
wherein the generating of the interim summary data comprises
excluding the small talk text by utilizing few-shot learning using a prompt comprising a definition of the small talk and an example corresponding to the small talk text.

4. The method for generating meeting minutes based on generative AI of claim 2,
wherein the generating of the interim summary data comprises,
in a case where generation of the interim summary data is impossible when the small talk text is excluded from the data chunk, displaying the data chunk as a preset identifier.

5. The method for generating meeting minutes based on generative AI of claim 4,
wherein the generating of the topic text comprises
filtering out the data chunk indicated by the identifier and then generating the topic group.

6. The method for generating meeting minutes based on generative AI of claim 1,
wherein the generating of the topic-wise summary data further comprises:
identifying whether small talk text corresponding to predefined small talk is included in the topic-wise summary data using the large language model; and
in a case where small talk text is included, removing the small talk text from the topic-wise summary data using the large language model.

7. The method for generating meeting minutes based on generative AI of claim 6,
wherein the identifying of whether the small talk text is included comprises
identifying whether the small talk text is included using few-shot learning using a prompt comprising definition of the small talk and an example corresponding to the small talk text.

8. The method for generating meeting minutes based on generative AI of claim 7,
wherein the identifying of whether the small talk text is included comprises
further inputting the topic text corresponding to the topic-wise summary data into the large language model to reflect similarity with the topic text when identifying whether the small talk text is included in the topic-wise summary data.

9. The method for generating meeting minutes based on generative AI of claim 1,
wherein the generating of the topic text comprises
variably configuring the number of topics corresponding to the number of the topic groups and the reference numbers of the data chunks included in the topic groups, depending on the number of generated data chunks.

10. The method for generating meeting minutes based on generative AI of claim 9,
wherein the generating of the topic text comprises:
in a case where the number of data chunks is C, where the number of topics is T, and where the maximum reference number is M (C, T, and M are all integers greater than or equal to 0), obtaining the number of topics (T), which is a minimum value that satisfies both C≤T*M and M=T−1, depending on the number of data chunks (C); and
configuring the reference numbers of the topic groups, respectively, according to the number of topics (T).

11. The method for generating meeting minutes based on generative AI of claim 1,
further comprising collating the topic-wise summary data to generate topic-specific meeting minutes corresponding to the meeting.

12. A computer program stored in a medium to execute, in combination with hardware, the generative AI-based meeting minutes generation method of claim 1.

13. A computing device for generating meeting minutes based on generative AI (artificial intelligence), the computing device comprising a processor,
wherein the processor is configured to:
collect transcript text generated during a meeting to generate respective data chunks for every configured unit;
summarize the transcript text included in the data chunks to generate interim summary data for each data chunk using a large language model (LLM);
group the data chunks by reference number to generate multiple topic groups and generate topic text encompassing the interim summary data for each topic group using the large language model; and
input the topic text and the interim summary data for each topic group into the large language model to generate topic-wise summary data obtained by summarizing the interim summary data according to the topic text.

14. The computing device of claim 13,
wherein, in generating the interim summary data,
small talk text corresponding to predefined small talk is excluded from the transcript text included in the data chunk, thereby generating the interim summary data, using the large language model.

15. The computing device of claim 14,
wherein, in generating the interim summary data,
the small talk text is excluded by utilizing few-shot learning using a prompt comprising a definition of the small talk and an example corresponding to the small talk text.

16. The computing device of claim 14,
wherein, in generating the interim summary data,
in a case where generation of the interim summary data is impossible when the small talk text is excluded from the data chunk, the data chunk is displayed as a preset identifier.

17. The computing device of claim 16,
wherein, in generating the topic text,
the topic group is generated by filtering out the data chunk indicated by the identifier.

18. The computing device of claim 13,
wherein the generating of the topic-wise summary data further comprises:
identifying whether small talk text corresponding to predefined small talk is included in the topic-wise summary data using the large language model; and
removing, in a case where small talk text is included, the small talk text from the topic-wise summary data using the large language model.

19. The computing device of claim 13,
wherein, in generating the topic text,
the number of topics corresponding to the number of the topic groups and the reference numbers of the data chunks included in the topic groups are variably configured depending on the number of generated data chunks.

20. The computing device of claim 19,
wherein, in generating the topic text,
in a case where the number of data chunks is C, where the number of topics is T, and where the maximum reference number is M (C, T, and M are all integers greater than or equal to 0), the number of topics (T), which is a minimum value that satisfies both C≤T*M and M=T−1, is obtained depending on the number of data chunks (C), and the reference numbers of the topic groups are respectively configured according to the number of topics (T).
